(19) United States
(12) Patent Application Publication
(10) Pub. No.: US 2006/0171256 A1
(43) Pub. Date: Aug. 3, 2006

(54) Global timepiece with double day/double date rendering

(76) Inventor: Keith Herbert, Boynton Beach, FL (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/184,942

(22) Filed: Jul. 19, 2005

Related U.S. Application Data
(60) Provisional application No. 60/649,864, filed on Feb. 3, 2005.

(51) Int. Cl. G04B 19/22

(52) U.S. Cl. 368/21

(57) ABSTRACT

A global timepiece includes a 24 hour movement mechanism in a case, the mechanism has rotatable shaft(s) or other drive mechanism that extend through or around the face and is (are) connected to an hour hand, a minute hand, optionally a second hand, and a transparent disk. Optionally, a bezel rotatably connected to or inside the case has hour/minute indicia. The face can also define hour/minute indicia, as well as New Day Line indicia, having dual day and dual date windows on each side of the New Day Line. Optional features include a 24 hour alarm on the face. The transparent disk preferably is positioned above the face, rotates once every 24 hours, and contains International Date Line indicia; time zone indicia represented by cities or other indicia and Daylight Savings Time conversion indicia. Optionally, the case has a pair of connectors attached to opposing ends of the case to receive a pin to secure a wristband to the case.

### CROSS REFERENCE TO RELATED APPLICATION

This application claims the benefits of U.S. Provisional Patent Application Ser. No. 60/649,864, filed Feb. 3, 2005, which application is hereby incorporated by reference in its entirety.

### BACKGROUND OF THE INVENTION

1. Field of the Invention

The present invention generally relates to watches, clocks and other timepieces, and, more particularly, to a watch that indicates global times.

2. Brief Description of the Presently Available Technology

Time pieces that display times in different geographical areas of the world, e.g., global timepieces, are disclosedlosed in U.S. Pat. Nos. 197,246 to Cates; 693,814 to Davis; 2,056,038 to DeAngelis et al.; 2,910,825 to Kirkwood; 3,091,915 to Pawl; 5,054,008 to Darling; 5,745,440 to Chen; and 6,243,324 B1 to Teng.

Although each of the timepieces disclosedlosed in the above-mentioned patents are acceptable for their intended purposes, there are limitations, e.g., lack of space on the dial face to provide additional and relevant information to the wearer. For example, generally world timepieces have either rotatable outer rings (e.g., Patek Phillippe style watches) or a small central rotatable faceplate (e.g., Walden style watch) both covering a portion of the dial or bezel with geographical time zone indicia using city or other name indicia. Although fully functional, the design of these timepieces limits the amount of information that can be displayed. More particularly, the dial of the presently available timepieces, e.g., analog type watches is mostly filled or obscured with time zone rings or plates, and thus there is little or no room to provide additional relevant information, e.g., displays such as chronograph (stop watch), power reserve indicator, moon phase indicator, alarm indicator, etc. Further, in the second instance, the present 24 hour world time watches do not display both days and both dates that exist simultaneously across the world and do not display which time zones are in which day and which date and do not display how the day and the date change for each time zone from hour-to-hour and do not do so in a manner to allow space on the traditional size watch face or dial for display of various other traditional information such as, but not limited to, chronograph, power reserve indicator, alarm, moon phase, and so forth.

As can be appreciated by those skilled in the art, it would be advantageous to provide a global timepiece that does not have the limitations of the presently available timepieces; more particularly, a global analog type timepiece that provides for displaying the time in all of the world's 24 time zones as well as displays additional information, e.g., but not limited to, power reserve indicator, moon phase indicator, alarm indicator, etc.

### SUMMARY OF THE INVENTION

This invention relates to a world or global analog type display timepiece having, among other things, a mechanical or other type of drive mechanism to move components discussed below to, among other things, (1) simultaneously displays the world's 24 time zone times, and the two days and two dates that continuously exist across the world; (2) shows which of the 24 time zones are in which of the simultaneously existing two days and two dates; (3) shows how the day and date of each time zone change hour-by-hour and day-by-day, and (4) presents this information in a new and unique manner such as to allow easy reading and more available area on the dial to present additional other dial indicators singularly or multiply to show additional information such as chronograph (stop watch) sub-dials, power reserve indicator, moon phase indicator, alarm indicator, etc.

In one non-limiting embodiment of the invention, the global timepiece includes, among other things, a dial having an analog face adjacent a transparent time disk displaying 24 separate time zones. The analog face includes dual side-by-side date windows and dual side-by-side day windows cut open through the dial opening to expose adjacent days and dates on normal day and date rings or plates under the dial; both the two day windows and the two date windows are located on the dial astride the New Day Line defined below. A series of drive shafts or other drive mechanism is provided to rotate the transparent time disk of glass, plastic or other similar material 360 degrees once every 24 hours, and to rotate an hour hand, a minute hand and optionally a second hand. Optionally, there may be an hour hand which can be set to any desired hour, e.g., time zone, for quick and easy reference to the wearer's or other desired time zone. In the preferred embodiment of the invention, the preferably transparent disk has all of the 24 time zones indicated with either a mark or name. In addition, the transparent disk displays an International Date Line running from the disk center in a straight line to the outer edge opposite the time zone sometimes named Greenwich Mean Time (hereinafter also referred to as “GMT”) or London time zone.

The New Day Line is a line, preferably a straight line running on the surface of the dial from the center point to the midnight indice on or near the outer edge of the dial. Thus, the International Date Line on the disk will rotate over the dial once every 24 hours and will cross over the stationary New Day Line when it is midnight at the International Date Line at which moment the next new day begins, and at which time the day and date wheels both rotate, e.g., click counterclockwise which action is a part of a non-limiting embodiment of the invention not presently available on present watches having day and date windows. With the above arrangement, at any moment, with a quick glance, the reader can instantly, easily and without any adjustments, read the time, day and date of all time zones in the 24 time zones. The combination of the disk and dial provide a new and unique watch design, that provides room on the dial for various other traditional displays including, but not limited to, a chronograph, a moon phase indicator, a power reserve indicator and alarm function.

In a further non-limiting embodiment of the invention, the global timepiece incorporating features of the invention includes a case that houses a movement mechanism having a rotatable shaft. A face, e.g., a dial face is positioned immediately adjacent to the movement mechanism, with the rotatable shaft extending orthogonally through the face. An hour hand, a minute hand, optionally a second hand, and a transparent disk, suspended or positioned over and covering all or most of the dial face, are each spaced apart from one another and are each spaced apart from the face in any convenient manner. Double date face windows and double day face windows are, each pair, positioned astride the New Day Line which is a non-limiting embodiment of the invention and which extends from the center of the face to the midnight indice located on the circumference of the face. Traditional seven day (or multiples thereof) and thirty-one date wheels are set under the windows and both wheels rotate counterclockwise which is different from presently available day and date wheel watches. In another non-limiting embodiment of the invention, a bezel is rotatably connected to the outside or set inside the case or fixed with respect to the case.

In another non-limiting embodiment of the invention, the case has a pair of connectors, with each pair of connectors attached to opposing ends of the case and each pair of connectors having a first prong and a second prong spaced away from the first prong. The first prong defines a first pin orifice and an internally-threaded hollow end piece positioned at one end of the first pin orifice. The second prong defines a second pin orifice and a pinhead depression, wherein the second pin orifice is aligned along the same imaginary longitudinal axis as the first pin orifice. A pin having a pinhead, a pin shaft, and an externally-threaded end is inserted through the second pin orifice and screwed into the first pin orifice. The pinhead is moveable in a lateral direction along the imaginary longitudinal axis and contains an internal clutch mechanism, such that the pinhead can be moved in a direction away from the first and second pin orifices, and rotated in a left or counterclockwise direction. Rotation of the pinhead in the counterclockwise direction causes the pin shaft to rotate to the left or counterclockwise direction, which unthreads the pin from the first pin orifice. Alternatively, the internally hollow end piece can have a retractable, internally-threaded, spring-loaded collar positioned in the hollow end piece, and the pinhead can be integrally formed with the pin shaft.

In a still further non-limiting embodiment of the invention, the bezel can further co-define hour/minute indicia in a sixty (minute) and 24 (hour) dual unit scales so that the wearer can set the zero point to either the minute hand to time events up to sixty minutes or to the hour hand to time events up to 24 hours. The indicia can be luminescent and can also be color-coded to visually help differentiate between minute and hour readings. A pair of opposing date windows may also be defined by the case.

In still another non-limiting embodiment of the invention, the dial face can also define hour/minute indicia, as well as the New Day Line indicia. The New Day Line is preferably a straight line positioned from the center of the dial to outer circumference of the dial at the midnight indicia positioned on the bezel or the face. The face or the New Day Line can be luminescent. Additional information, such as a power consumption, moon phases, or other data, can also be included on the face.

In a further non-limiting embodiment of the invention, the transparent disk preferably floats, e.g., is mounted for rotation above the face, and preferably rotates 360 degrees once every 24 hours. In any event, the disk will allow dual day/date windows positioned astride the New Day Line to be seen through the disk. The transparent disk preferably contains International Date Line indicia; time zone indicia represented by cities or areas geographically located within each corresponding time zone and Daylight Savings Time Conversion indicia (hereinafter also referred to as “DSTC”). The DSTC indicia is an improved version in that there are indices that provide for compensation for locations that do not adopt Daylight Savings Time as well as other indices that provide for compensation for locations that adopt Daylight Savings Time opposite to the standard Daylight Savings Time months, e.g., a watch set up for reading Northern Hemisphere Daylight Savings Time as standard will have to compensate for southern hemisphere locations which observe Daylight Savings Time generally opposite to the Northern Hemisphere.

The face may be color coded to show daylight hours and evening hours, and may also be luminescent. An “A” or “P” may also be posted next to the dial numbers instead of, or in addition to, color-coding to assist in reading A.M. or P.M. hours.

An additional non-limiting embodiment of the invention includes a one to 24 hour alarm dial and function on the main dial face that is set independently of the time indicated or shown on the face of the watch, rather is set forward from the time of setting to up to 24 hours in advance which would be a feature of particular interest to world travelers who will calculate the time desired for an alarm not against the local time but against the number of hours forward for events that may be occurring anywhere in the world.

As can be appreciated, the drive mechanism of the time piece incorporating features of the invention can be powered in any convenient manner, for example, but not limited thereto, by tightening a spring, by wrist movement, or by electrical current e.g., and not limiting to, a battery, solar energy, and house current.

As can now be appreciated, the present invention allows a significant additional amount of information to be displayed to a wearer or observer not readily possible with current world time designs. For example, by including the transparent disk, the dial face area formerly covered with city or number wheels is now available for other traditional displays such as chronograph, power reserve indicator, alarm, moon phase indicator, and other information which can be included on the face. Further, watch band changes can be accomplished quickly.

These and other advantages of the present invention will be clarified in the description of the preferred embodiment taken together with the attached drawings, in which like reference numerals represent like elements throughout.

### BRIEF DESCRIPTION OF THE DRAWINGS

FIG. 1 is a top plan view of a non-limiting embodiment of a global timepiece of the present invention, which includes, but is not limited to, a transparent disk, an hour, minute and second hands, a bezel and a face with dual day and dual date window;

FIG. 2 is a top plan view of another non-limiting embodiment of a bezel incorporating features of the invention;

FIG. 3 is a top plan view of another non-limiting embodiment of a face incorporating features of the invention;

FIG. 4 is a breakaway view of a non-limiting embodiment of a timepiece of the invention showing a perspective view of a non-limiting embodiment of a transparent disk of the invention;

FIG. 5 is an orthogonal view of a non-limiting embodiment of a strap connector of the invention; FIG. 5 shows the strap connector disassembled, and FIG. 5A shows the strap connector assembled;

FIG. 6 is a top plan view of a further non-limiting embodiment of a timepiece of the invention showing a non-limiting embodiment of a face of the invention with a 24 hour alarm set by a pin protruding from the case; and

FIG. 7 is an illustration of a preferred non-limiting embodiment of a global wristwatch of the invention.

### DETAILED DESCRIPTION OF THE PREFERRED EMBODIMENTS

As used herein, spatial or directional terms, such as “inner”, “outer”, “left”, “right”, “up”, “down”, “horizontal”, “vertical”, and the like, relate to the invention as it is shown in the drawing figures. However, it is to be understood that the invention can assume various alternative orientations and, accordingly, such terms are not to be considered as limiting.

Before discussing non-limiting embodiments of the invention, it is understood that the invention is not limited in its application to the details of the particular non-limiting embodiments shown and discussed herein since the invention is capable of other embodiments. Further, the terminology used herein to discuss the invention is for the purpose of description and is not of limitation. Still further, unless indicated otherwise in the following discussion, like numbers refer to like elements.

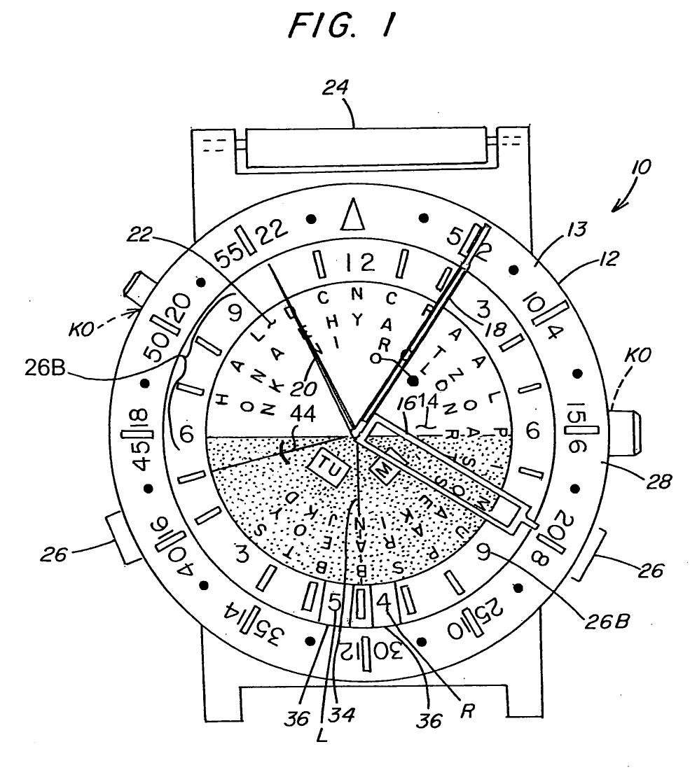

Shown in FIG. 1 is a non-limiting embodiment of a universal global timepiece 10 incorporating features of the invention. The timepiece 10 of the invention shown in FIG. 1 is a wristwatch, however, the invention is not limited thereto and the timepiece 10 can be a pocket watch, a table watch, a wall clock, a floor clock, or a locket watch pinned on clothing or hung on a chain or other mode of timepiece presentation. The timepiece 10 shown in FIG. 1 includes a case 12, a bezel 13, a face or dial face 14, an hour hand 16, a minute hand 18, a second hand 20, a transparent disk 22, and a wristband 24. As can be appreciated, the invention contemplates additional features, e.g., but not limiting to the invention, a double day indicator, a double date indicator, and a rotating International Date Line indicator converging with a stationary New Day Line indicator, which features are discussed in detail below. Further, the invention contemplates using some but not all the components of the wristwatch shown in FIG. 1, e.g., but not limiting to the invention, a different bezel design can be used with, or the bezel and/or wristband can be removed from, the timepiece of the invention.

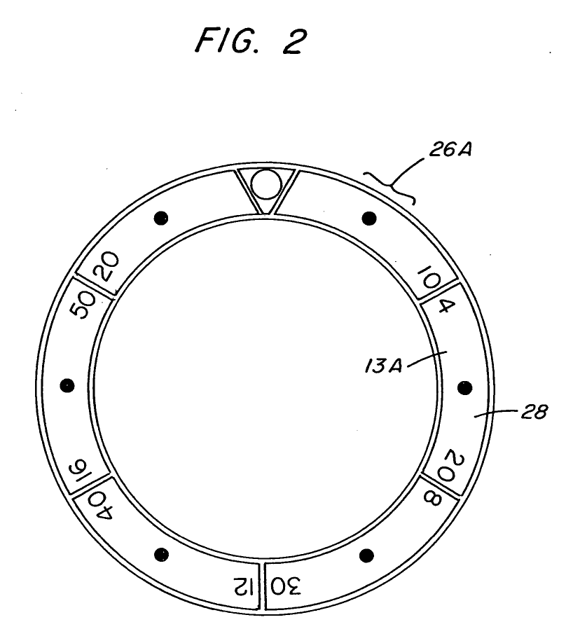

The case 12, shown in FIG. 1, preferably defines a generally circular shape, however, the invention is not limited thereto and can have any shape, e.g., but not limiting to the invention, a polygonal shape having three or more sides, or an elliptical shape. The case 12 can be made of any material, e.g., but not limiting to the invention, wood, metal or plastic and is preferably made from a corrosion-resistant metal or plastic. One or more setting buttons or knob orifices (hereinafter also referred to as “KO”) (shown in FIG. 1) or other types of mechanisms to activate elements of the timepiece are mounted on the case 12 with the shaft (not shown) of the setting buttons KO extending into the case 12 and connected to moveable components (not shown) of the watch, e.g., but not limiting to, the hour hand 16, the minute hand 18, the second hand 20, and the transparent disk 22, to set the components to a desired position in a manner known in the art. The bezel 13 shown in FIG. 1, or bezel 13A shown in FIG. 2, can be positioned adjacent to the case 12 or inside the case and rotatable with respect to hour/minute indices 26B on face 14. The bezel 13 and 13A preferably defines etched minute/hour indicia 26, 26A, respectively, provided on a first bezel surface 28, with the minute/hour indicia 26, 26A (see FIGS. 1 and 2) preferably arranged in a 60 minute/24 hour arrangement, wherein the hours can be 24 consecutive hours. Although not limiting to the invention, the hours of the minute/hour indicia 26, 26A can be colored coded to assist with differentiating between reading the minute versus the hour scale and can also be coated with a luminescent material to allow the minute/hour indicia 26, 26A to be seen in dimly lit areas. Alternatively, the bezel 13, 13A itself can also be illuminated.

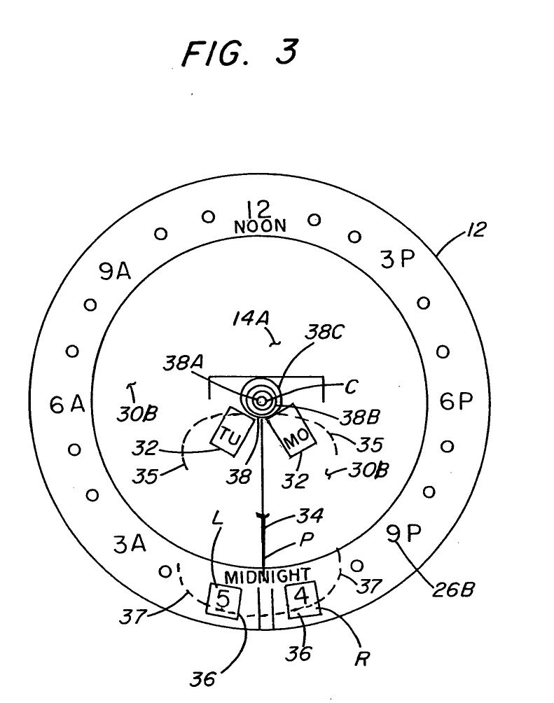

With continuing reference to FIG. 1 and with further reference to FIG. 3, the face 14, 14A of the global timepiece 10 is preferably circumscribed by the case 12. FIG. 1 shows a first non-limiting embodiment of the face 14. FIG. 3 shows another non-limiting embodiment of the face 14A. As shown in FIGS. 1 and 3, the face 14, 14A can also define minute/hour indicia 26B. The minute/hour indicia 26B shown in FIGS. 1 and 3 can be interchanged with the minute/hour indicia 26, 26A shown on the bezel 13, 13A (FIGS. 1 and 2) or can be combined to form any other 1 to 24 hour arrangement. The indices 26B on face 14 can be divided into one set of one through twelve segments for the morning hours, and a second set of one through twelve segments for the evening hours. Color-coding to show morning and evening hours can also be interchanged, as appropriate. In another non-limiting embodiment of the invention, all indicia described above can be illuminated or coated with luminescent material.

As shown clearly in FIG. 3 and with reference to FIG. 1 as needed, a first surface 30B of the face 14, 14A defines a pair of day windows 32 positioned on opposite sides of stationary New Day Line indicia 34. The New Day Line indicia 34 is on the first surface 30B of the face 14, 14A and extends from center C of the face 14, 14A to the twelve A.M. (midnight) hour point P on the face 14, 14A. The face 14, 14A can also define a pair of date windows 36 positioned on opposite sides of the New Day Line indicia 34. Although the day windows 32 are shown adjacent the center of the face 14, 14A, and the date windows 36 are shown adjacent the periphery of the face 14, 14A, the invention is not limited thereto and the day windows and date windows can be positioned at any position from the periphery to the center of the face 14, 14A.

A thirty-one day rotatable wheel 35 (partially shown in phantom, shown only in FIG. 3) can be positioned beneath each one of the pair of date windows 36, between the face 14, 14A and the case 12, with the rotatable wheel 35 preferably rotating 360 degrees every thirty-one days. A seven day date wheel 37 (partially shown in phantom, shown only in FIG. 3) can be positioned beneath the pair of day windows 32, also preferably between the face 14, 14A and the case 12, with the seven day date wheel 37 rotating 360 degrees every seven days. The day wheel 35 and the date wheel 37 are preferably synchronized with the minute hand 18 and the disk 22, and both day and date wheels rotate counterclockwise. Because there are two date windows 36, day number thirty-one can be written with the “3” detached from the “1”, e.g., but not limiting to the invention, as “3/1”, or similarly so that months having thirty days will prompt the wearer or viewer to read the date window 36 to the left of the New Day Line indicator 34 (left window designated as “L”) as “1”. When the date designated as “3/1” moves to the opposite right date window 36 (window to the right of new date line indicator designated as “R”), the date wheel 37 can be rotated by the wearer or viewer so that a “1” appears in right R date window 36 and a “2” appears in the left L date window 36 in the same manner as present design date wheels are cycled on months with less than thirty-one days.

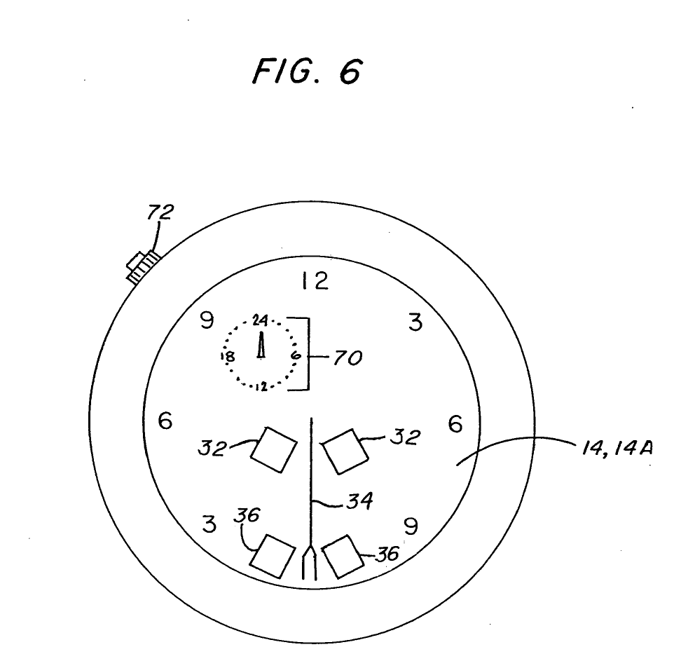

Additional information, or other data, can also be included on any of the faces 14, 14A. For example and not limiting to the invention, FIG. 6 shows a 24 hour alarm dial 70 positioned on any of the faces 14, 14A, with the dial 70 actuated by knob 72 in any usual manner. More particularly, the alarm clock has a one to 24 hour alarm dial and function on the main dial face that is set independently of the time indicated or shown on the face of the watch. The alarm time is set forward from the time of setting up to 24 hours in advance, and is useful to calculate the time desired for an alarm not against the local time but against the number of hours forward for events that may be occurring anywhere in the world. Further, the dial face as shown in FIG. 6 has room to provide other features, for example, but not limited to a chronograph (stop watch), a power reserve indicator, a moon phase indicator, an alarm indicator, etc.

With continuing reference to FIG. 3 but with equal applicability to FIGS. 1 and 2, the hour hand 16 is connected to a first rotatable shaft 38 positioned at the center C of the face 14, 14A and extending orthogonally away from the face 14, 14A. The minute hand 18 is connected to a second rotatable shaft 38A, with the minute hand 18 spaced away from both the face 14, 14A and the hour hand 16. Similarly, the second hand 20 is connected to a third rotatable shaft 38B and is spaced away from the face 14, 14A, the hour hand 16, and the minute hand 18. The transparent disk 22 is connected to a fourth rotatable shaft 38C and is spaced from the face 14, 14A with the hour hand 16, the minute hand 18, and the second hand 20 between the face 14, 14A and the transparent disk 22. In other non-limiting embodiments of the invention, the hour hand 16 can be attached with the transparent disk 22 to the same shaft 38C and can be moved independently, or the hour hand 16 can be attached to a second hour shaft or otherwise constructed in any manner by those skilled in the art.

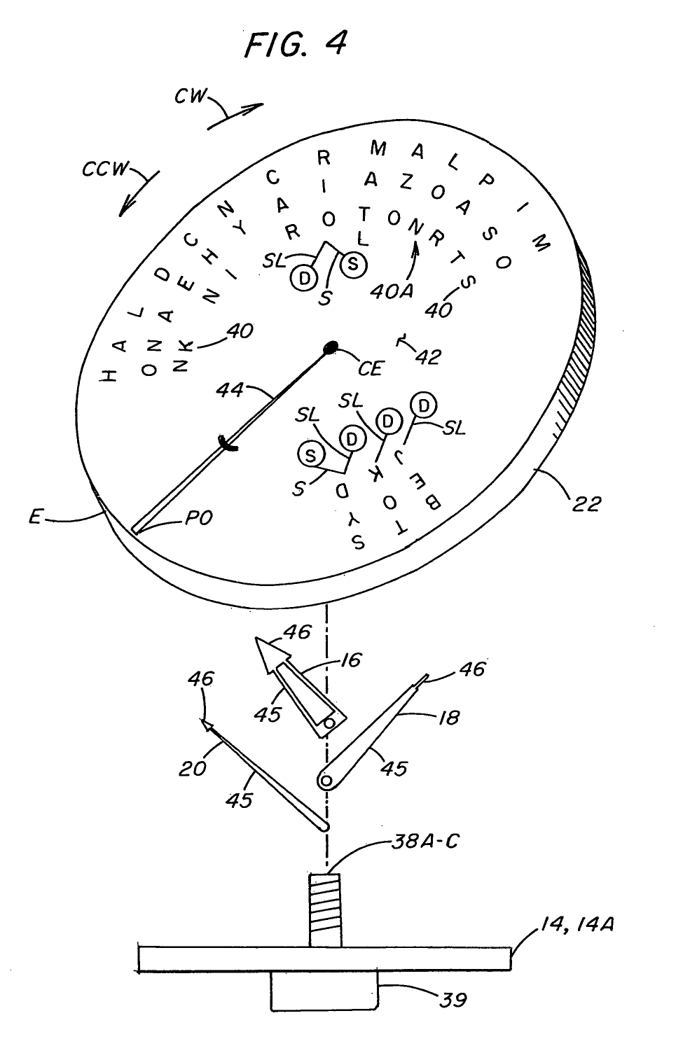

As can be appreciated by those skilled in the art the invention is not limited to a driving arrangement 39 (shown only in FIG. 4), for example, and not limiting to the invention, the driving arrangement 39 includes gear arrangement and a powering unit, and any of the types known in the art can be arranged to practice the non-limiting embodiments of the invention disclosed herein. For example, and not limiting to the invention, the gear arrangement can be powered by manually, e.g., and not limiting to the invention, by tightening a spring, or with wrist movement or electrically e.g., and not limiting to, a battery, solar energy, and house current.

In a preferred non-limiting embodiment of the invention, the disk 22 and the minute hand 18 occur simultaneously to set world time and are movable by one of the setting buttons KO or other activation device. The hour hand 16 is preferably actuated by an independent setting button, e.g., but not limiting the invention thereto, the other one of the setting buttons KO, to set local time. Local time can be set according to the city or time zone where the wearer is currently standing by moving the hour hand 16 to that particular city or time zone. Once set, the hour hand 16 rotates coincident with the transparent disk 22 and the local time of the city. Changing the local hour hand from one local time to another when the wearer changes time zone locations does not change the position of the disk 22, which indicates the world time because world time does not change as people move across it. Accordingly, once set, the watch time, day or date need never be re-set due to the travel of the wearer. The traveling wearer need only rotate the hour hand to the new time zone and he or she is finished.

In another and preferred non-limiting embodiment of the invention, the order is the face 14, 14A, the disk 22, the hour hand 16 (with a cut-out viewing window as shown in FIG. 4 so that the disk indicia can be seen), the minute hand 18, and the second hand 20. With the disk 22 adjacent to the face 14, 14A, the disk is transparent. Although not limiting to the invention, the first, second, third, and fourth rotatable shafts 38-38C are preferably nested hollow shafts, or other standard movement arrangement. For example, U.S. Pat. No. 5,742,565 to Cuinet et al., herein incorporated by reference in its entirety, disclosesloses a typical three-hand movement with two crowns.

Although not limiting to the invention, the hour hand 16 rotates 360 degrees once every 24 hours; the minute hand 18 rotates 360 degrees every sixty minutes, and the second hand 20 rotates 360 degrees every sixty seconds. The hour hand 16 will normally be set at the time zone local to the wearer or observer so that local geographical time can be determined at a glance. Rotation of the rotatable shafts 38-38C, the date wheel 37 (see FIG. 3), and the day wheel 35 (see FIG. 3) can be accomplished through the driving arrangement 39 (see FIG. 4), a manual or electronically-driven or otherwise powered timepiece movement mechanism is readily understandable to one skilled in the art.

With continuing reference to FIGS. 1 and 3, and with further reference to FIG. 4, the transparent disk 22 defines a generally circular shape and is subdivided into 24 hour time zones. As partially shown in FIG. 4, the times zones are indicated by geographical indicia 40, which are preferably etched onto a first disk surface 42 of the transparent disk 22 and preferably painted with a highly luminous and visible paint. The transparent disk 22 is spaced away from the face 14, 14A, the hour hand 16, the minute hand 18, and the second hand 20. International Date Line indicia 44 extends from a center CE of the transparent disk 22 to an outermost edge E of the transparent disk 22 at a point PO opposite to and aligned with the indicia 40A, which indicates Greenwich Mean Time (GMT), such as London, England, or Keflavik, Iceland.

As noted above, the hour hand 16, minute hand 18, second hand 20, and transparent disk 22 all rotate above the first surface 30B of the face 14, 14A. The time zones on the disk are spaced from one another to correspond to the distance between the hours on the dial face. By referring to the geographical indicia 40 positioned on transparent disk 22, a wearer or observer can also instantly determine the local time of any other time zone in the world. For example and not limiting to the invention, if Tokyo (“TOK”) indicia positioned on the transparent disk 22 is coincident or points to the 0200 or 2:00 AM indicia positioned on the face 14, 14A, it is 0200 local time in Tokyo. GMT or Zulu time can also be determined by viewing the local time for London (“LON”), Keflavik, or other suitable geographically located city. Further, the wearer or observer can also determine the present day and date for all time zones by referring to the New Day Line indicia 34 (see FIG. 1) positioned on the first surface 30B of the face 14, 14A and the International Date Line 44 positioned on the transparent disk 22 (see FIG. 4). Those geographical locations positioned on the transparent disk 22, which are located between the New Day Line indicia 34 clockwise to the International Date Line 44, will be in the day/date indicated in the day/date windows 32, 36 on the left side L of the New Day Line indicia 34, while those time zones between the New Day Line indicia 34 counterclockwise to the International Date Line 44 will be in the day/date windows 32, 36 indicated on a right side R of the New Day Line indicia 34.

With continuing reference to FIG. 4, most Northern Hemisphere countries observe Daylight Savings Time (DST), so calibrating the watch to Northern Hemisphere Daylight Savings Time observing countries and setting the local time in the U.S. will automatically compensate for DST in most Northern Hemisphere countries. The few Northern Hemisphere countries that do not observe DST, such as Beijing, China, and Tokyo, Japan will have their local time pushed back during Northern Hemisphere DST one time zone relative to the others. To help correct for DST for non-complying time zone cities, these time zone cities located on the transparent disk 22 have a short line SL extending from the city in a counterclockwise CCW direction, and have a “D” indicia positioned at the end of the short line SL. The “D” indicates that during DST, that particular time zone (relative to most of the Northern Hemisphere observing DST) is represented by the time zone in the hour before the actual location of the time zone.

For watches calibrated to Northern Hemisphere Daylight Savings Time observing countries, countries located south of the equator present a more complicated DST problem. Most countries geographically located south of the equator do not observe DST, and those that do are on DST when Northern Hemisphere countries are observing standard time (“ST”). Two major southern hemisphere cities that observe southern DST are Sydney, Australia and Rio de Janeiro, Brazil. Accordingly, with this version of the watch reading the time from the perspective of the Northern Hemisphere, these locations will have the same “D” line device running to the adjacent time zone in the counterclockwise direction CCW, similar to the Tokyo and Beijing examples discussed above. However, Southern Hemisphere countries observing Daylight Savings Time opposite to the Northern Hemisphere, including Sydney and Rio de Janeiro will also have an “S” line indicia running in clockwise direction CW, one time zone to the right. The “S” line indicia indicates that during standard time in the Northern Hemisphere, Sydney and Rio de Janeiro will be on their own DST and, thus, will be one hour ahead of their regular time difference with respect to the Northern Hemisphere.

In another non-limiting embodiment of the invention, bodies 45 and/or ends 46 of the hour hand 16, the minute hand 18, and the second hand 20 can have different configuration to quickly distinguish between the hour, minute, and second hands. For example and not limiting to the invention, the body 45 of the minute hand 18 is thicker than the body 45 of the second hand 20, whereas the body 45 of the hour hand 16 has a hole in its body 45. Further, the second hand 20 has an arrowed end 46, the minute hand 18 has a pointed end 46, and the hour hand 16 has an arrowhead larger than the arrowhead of the second hand 20. As can now be appreciated, hands 16, 18, 20 can have any type of end design.

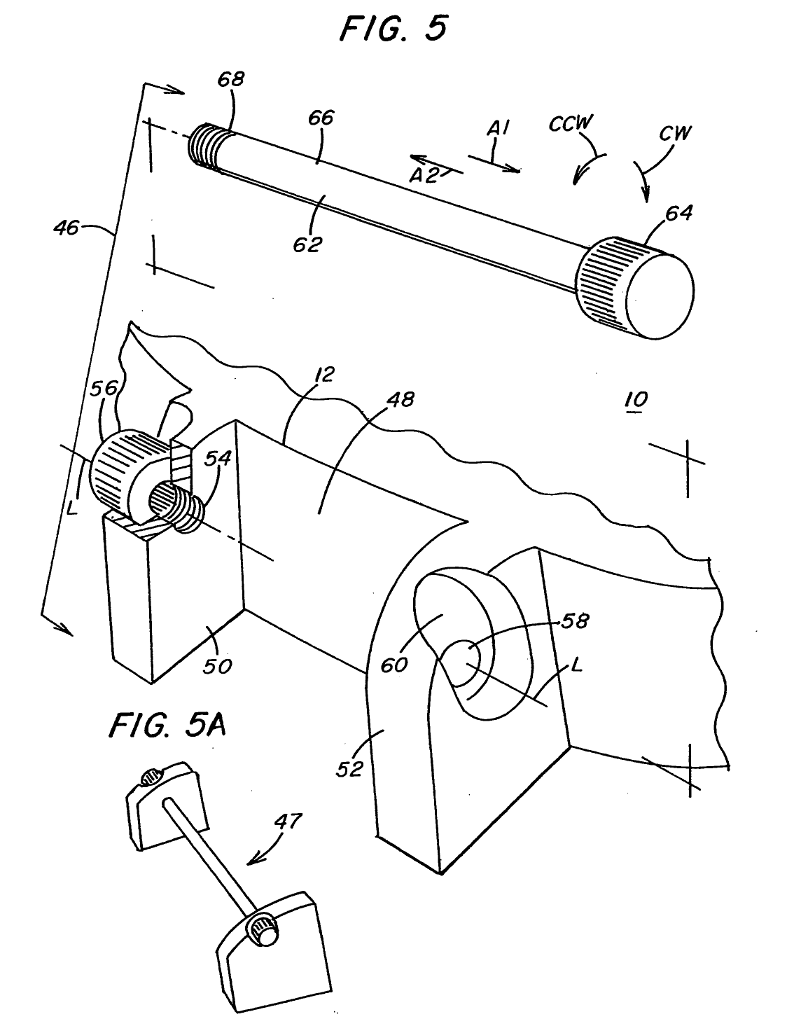

The invention also relates to a wristband connector 48 that is easy to assemble and disassemble to attach or remove, respectively, an end of the wristband from the timepiece 10. In a non-limiting embodiment of the invention, the timepiece 10 has a pair of opposite connectors 48 (only one shown in FIG. 5). Each of the connectors 48 has a first prong 50 and a second prong 52 spaced away from the first prong 50. The first prong 50 defines a first pin orifice 54 and an internally threaded hollow end piece 56 positioned at one end of the first pin orifice 54. The second prong 52 defines a second pin orifice 58 and a pinhead depression 60, wherein the second pin orifice 58 is aligned along the same imaginary longitudinal axis L as the first pin orifice 54. A pin 62 having a pinhead 64, a pin shaft 66, and an externally threaded end 68 is inserted through the first pin orifice 54 and the second pin orifice 58. The pinhead 64 is moveable in a lateral direction along the imaginary longitudinal axis L and contains an internal clutch mechanism, like current time setting crowns, such that the pinhead 64 can be moved in an A1 direction away from the first and second pin orifices 54, 58, rotated in a left or counterclockwise direction CCW. Rotation of the pinhead 64 in the counterclockwise direction CCW causes the pin shaft 66 to rotate in the left or counterclockwise direction CCW, which unthreads the pin 62 from the second pin orifice 58. Installation of the pin 62 is accomplished by rotating the pin 62 in the right or clockwise direction CW until the externally threaded end 68 of the pin 62 tightens in the internally threaded hollow end piece 56. The pinhead 64 is then moved in an A2 direction toward the first and second pin orifices 54, 58 so that the pinhead 64 reseats in the pinhead depression 60. Alternatively, the internally threaded hollow end piece 56 can be configured with an internally-threaded, spring-loaded collar positioned in the hollow end piece 56, and the pinhead 64 can be integrally formed with the pin shaft 66. These arrangements allow for fast and convenient watchband replacements.

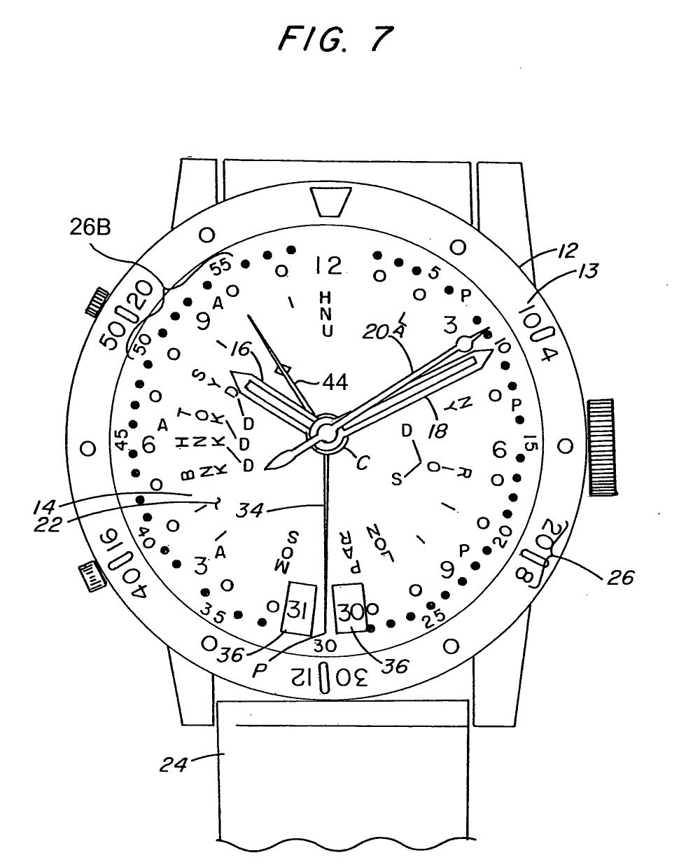

FIG. 7 is an illustration of a virtual prototype of a presently preferred non-limiting embodiment of the invention, prepared by the inventor. As with the non-limiting embodiments of the invention shown and described above, the prototype global timepiece in FIG. 7 includes a wristwatch having the case 12, the bezel 13, the face 14, the hour hand 16, the minute hand 18, and the second hand 20. The transparent disk 22 is also included on the virtual prototype, along with the wristband 24. The bezel 13 includes etched minute/hour indicia 26 and the stationary New Day Line indicia 34 located on the face 14 extending from the center C of the face 14 to the point P on the face 14. The windows 36 are located on either side of the stationary New Day Line 34. In most other material respects, the virtual prototype wristwatch shown in FIG. 7 is constructed and operates in the same manner as described in connection with the embodiments shown in the Figures and discussed above.

In conclusion, the present invention provides a universal global timepiece which displays the world time in a new and unique manner including for the first time showing the world's dual days and dual dates existing simultaneously across the globe as well as show which time zones are in which day and which date and how these change from hour-to-hour and day-to-day and does so while still allowing more room on the dial than present world time watches to allow for showing additional traditional related information Whenever the wearer chooses to change watchbands, a new watchband can be quickly installed. Minute/hour indicia are generally arranged in a 60 minute/24 hour format and can be positioned on the bezel, the face, or both. The bezel is rotatable, so that when a reference point on the bezel is aligned with the minute hand, elapsed minutes can be calculated as the minute hand continues to rotate after the bezel is set and, when aligned with the hour hand, elapsed hours can be calculated as the hour hand continues to rotate after the bezel is set.

The invention has been described with reference to the preferred embodiments. Obvious modifications and alterations will occur to others upon reading and understanding the preceding detailed description. For example, the bezel and/or the locking strap pin can optionally be omitted from the global timepiece according to the present invention. It is intended that the invention be construed as including all such modifications and alterations insofar as they come within the scope of the appended claims or the equivalents thereof.

The invention claimed is:

1. A global timepiece, comprising:
a case;
a movement mechanism having at least one rotatable shaft or other drive mechanism housed in the case;
a face positioned over the movement mechanism, with the at least one rotatable shaft or other drive mechanism extending through the face; and
an hour hand, a minute hand, and a disk, each spaced apart from one another and spaced from the face, wherein at least one of the hour hand, the minute hand, and the disk is operationally connected to the at least one rotatable shaft or other drive mechanism.

2. The global timepiece according to claim 1, wherein the disk is transparent.

3. The global timepiece according to claim 2, wherein the disk has a major surface generally parallel to the major surface of the face and a plurality of indicia on the major surface each of the indicia representative of a selected geographical time zone.

4. The global timepiece according to claim 3, wherein the major surface of the disk has a line defined as International Date Line, the International Date Line running in a straight line from a center of the disk to an outer edge opposite indicia indicating Greenwich Mean Time.

5. The global timepiece according to claim 1, wherein the face comprises a major surface, an indicia defined as a New Day Line on the major surface of the face and extending from the center of the face to the edge of the face, a first window on one side of the New Day Line, a second window on the other side of the New Day Line and aligned with the first window, a third window on the same side of the New Day Line and spaced from the first window, and a fourth window on the same side of the New Day Line as the second window and aligned with the third window, a first plate having days of the week, and second plate having a number in the range of 1 to 31, wherein the movement mechanism rotates the first and second plates to display both simultaneously existing days of the week on the first plate in the first and second windows, respectively, and to individually display both simultaneously existing dates of the month on the second plate in the third and fourth windows, respectively.

6. The global timepiece according to claim 5, wherein the disk is a transparent disk and the hour and minute hands are between the disk and the face.

7. The global timepiece according to claim 5 wherein the first and second plates both move in a counterclockwise direction.

8. The global timepiece according to claim 1, further comprising a bezel rotatably mounted on the case, the bezel having markings to indicate at least a 24 hour day.

9. The global timepiece according to claim 1, further comprising a marginal edge area surrounding the face and having markings to indicate at least a 24 hour day.

10. The global timepiece according to claim 9, wherein the marginal area is equally divided into two 12 hour periods.

11. The global timepiece according to claim 10, wherein luminescent New Date Line extends from the center of the face to an indice indicating midnight.

12. The global timepiece according to claim 9, further comprising a bezel rotatably mounted on the case and surrounding the marginal edge area.

13. The global timepiece according to claim 12, wherein the markings on the bezel define a 24 hour/60 minute format.

14. The global timepiece according to claim 6, wherein one 12 hour period is different than the other 12 hour period and the difference is selected from the group of color, design of number, and combinations thereof.

15. The global timepiece according to claim 1, further comprising a second hand spaced from the hour hand, the minute hand, and the disk, and free end of each hand has a different end configuration.

16. The global timepiece according to claim 1, wherein the disk comprises International Date Line indicia, time zone indicia represented by cities or areas geographically located within each corresponding time zone and Daylight Savings Time conversion indicia.

17. The global timepiece according to claim 11, wherein the face is color-coded to distinguish between daylight hours and evening hours.

18. The global timepiece according to claim 1, wherein the face comprises a 24 alarm dial.

19. The global timepiece according to claim 1, wherein the case further comprises:
a pair of connectors attached to opposing ends of the case, with each connector having a first prong and a second prong spaced away from the first prong,
wherein the first prong defines a first pin orifice and an internally-threaded hollow end piece positioned at one end of the first pin orifice, and the second prong defines a second pin orifice and a pinhead depression, with the first pin orifice and the second pin orifice aligned along an imaginary longitudinal axis; and
a pin comprising a pinhead, a pin shaft, and an externally-threaded end, wherein the pin is inserted through the first pin orifice and the second pin orifice,
wherein the pinhead is moveable in a lateral direction along the imaginary longitudinal axis and contains an internal clutch mechanism, such that the pinhead can be moved in a direction away from the first and second pin orifices, rotated in a left or counterclockwise direction until the internal clutch mechanism engages the pin shaft.

20. A global timepiece, comprising:
a transparent disk;
an International Date Line a New Day Line; and
double day and double date windows, each aligned astride the New Day Line, said timepiece showing the two days and two dates which continuously exist across the world, as well as which world locations are in which day and date and when the day and date for each world location changes.
